(19) United States
(12) Patent Application Publication
(10) Pub. No.: US 2026/0331635 A1
(43) Pub. Date: Oct. 22, 2026

(54) HEAT EXCHANGE ASSEMBLY, BATTERY APPARATUS, AND ELECTRIC APPARATUS

(71) Applicant: CONTEMPORARY AMPEREX TECHNOLOGY CO., LIMITED, Ningde (CN)

(72) Inventors: Cong Zhou, Ningde (CN); Xiaoteng Huang, Ningde (CN); Yuepan Hou, Ningde (CN); Bang Gao, Ningde (CN); Xuan Zhai, Ningde (CN)

(21) Appl. No.: 19/299,281

(22) Filed: Aug. 13, 2025

Related U.S. Application Data
(63) Continuation of application No. PCT/CN2025/089655, filed on Apr. 17, 2025.

(51) Int. Cl. H01M 10/6556; H01M 10/613; H01M 50/204; H01M 50/24; H01M 50/249

(52) U.S. Cl. CPC H01M 10/6556; H01M 10/613; H01M 50/204; H01M 50/24; H01M 50/249

(57) ABSTRACT

Embodiments of the present disclosure provide a heat exchange assembly, a battery apparatus, and an electric apparatus. The battery apparatus includes a casing, a heat exchange assembly, and a plurality of battery cells. The plurality of battery cells are disposed within the casing. The heat exchange assembly includes at least two heat exchange members, where at least one heat exchange member is configured as a flexible member, and at least one heat exchange member is configured as a rigid member. The flexible member and the rigid member are stacked to form at least one medium flow channel. The at least one medium flow channel is configured to conduct a heat exchange medium, where the heat exchange medium is configured to exchange heat with the plurality of battery cells. At least one of the flexible member and the rigid member includes an anti-corrosion layer.

### CROSS-REFERENCE TO RELATED APPLICATIONS

This application is a continuation of International Application No. PCT/CN2025/089655, filed on Apr. 17, 2025, which is incorporated herein by reference in its entirety.

### TECHNICAL FIELD

The present disclosure pertains to the field of battery technology, and in particular, to a heat exchange assembly, a battery apparatus, and an electric apparatus.

### BACKGROUND

In a new energy vehicle equipped with a battery apparatus, the battery apparatus can be configured to provide power entirely or partially. During use of the battery apparatus, battery cells within the battery apparatus generate heat. Excessive heat can adversely affect the performance and service life of the battery apparatus. Consequently, how to mitigate corrosion on a heat exchange assembly while effectively dissipating heat from the battery cells of the battery apparatus has become a significant research focus in the art.

### SUMMARY

In view of this, embodiments of the present disclosure aim to provide a heat exchange assembly, a battery apparatus, and an electric apparatus, capable of mitigating corrosion on the heat exchange assembly to some extent.

To this end, a first aspect of embodiments of the present disclosure provides a battery apparatus including:
a casing;
a plurality of battery cells, where the plurality of battery cells are disposed within the casing; and
a heat exchange assembly, where the heat exchange assembly includes at least two heat exchange members, at least one of the heat exchange members is configured as a flexible member, at least one of the heat exchange members is configured as a rigid member, the flexible member and the rigid member are stacked to form at least one medium flow channel, the at least one medium flow channel is configured to conduct a heat exchange medium, and the heat exchange medium is configured to exchange heat with the plurality of battery cells;
where at least one of the flexible member and the rigid member includes an anti-corrosion layer.

The battery apparatus provided by the embodiments of the present disclosure includes the casing, the heat exchange assembly, and the plurality of battery cells, where the plurality of battery cells are disposed within the casing, and the casing provides protection to the battery cells. The heat exchange assembly is configured to exchange heat with the battery cells. On one hand, at least one heat exchange member is configured as the flexible member, and the flexible member is lightweight. This is conducive to reducing the mass of the heat exchange assembly, lowering production costs of the heat exchange assembly, and reducing the mass of the battery apparatus. Additionally, the flexible member has a specified flexibility, so that the heat exchange assembly can better fit the casing and/or the battery cells, thereby facilitating the absorption of assembly tolerances of the heat exchange assembly without requiring sealants or thermally conductive materials, improving the fit between the heat exchange assembly and the casing and/or the battery cells, increasing an effective heat exchange area between the heat exchange assembly and the casing and/or the battery cells, and improving the heat exchange efficiency and heat exchange effect of the heat exchange assembly. On the other hand, configuring at least one heat exchange member as the rigid member, where the flexible member and the rigid member are stacked to form at least one medium flow channel, allows the rigid member to provide a support effect for the flexible member, which is conducive to improving the overall structural strength and stability of the heat exchange assembly, further improving the heat exchange efficiency and heat exchange effect of the heat exchange assembly. Moreover, providing the rigid member allows the heat exchange assembly to have sufficient structural strength to support the battery cells, thereby improving the applicability of the heat exchange assembly. On yet another hand, at least one of the flexible member and the rigid member is configured to include the anti-corrosion layer. The provision of the anti-corrosion layer is conducive to improving the corrosion resistance of the heat exchange assembly, mitigating the issue of corrosion on the heat exchange assembly caused by the heat exchange medium and external corrosive substances, thereby improving the reliability of the heat exchange assembly.

In some embodiments, the anti-corrosion layer includes a first anti-corrosion layer, and the rigid member is provided with the first anti-corrosion layer in at least a region where the medium flow channel is formed.

In these embodiments, providing the first anti-corrosion layer in at least the region of the rigid member where the medium flow channel is formed allows the first anti-corrosion layer to mitigate damage to the rigid member by the heat exchange medium, which is conducive to improving the reliability of the heat exchange assembly.

In some embodiments, a side of the rigid member facing the flexible member is covered with the first anti-corrosion layer.

This configuration can further mitigate damage to the rigid member by the heat exchange medium, further improving the reliability of the heat exchange assembly.

In some embodiments, the first anti-corrosion layer is configured as a metal-plastic composite film.

In these embodiments, the metal-plastic composite film has a small thickness and low weight, and the medium flow channel is formed between the metal-plastic composite film and the flexible member, so that the influence of an extrusion process is avoided, and the requirement for a large thickness does not need to be met. Therefore, the overall thickness and weight of the heat exchange assembly can be reduced. Additionally, the insulating properties of the heat exchange assembly can reduce the possibility of insulation failure. This reduces the possibility of reaction between the rigid member and the heat exchange medium flowing inside, further reducing the possibility of corrosion and leakage of the heat exchange medium.

In some embodiments, the first anti-corrosion layer is configured as an aluminum-plastic film.

The aluminum-plastic film exhibits high barrier properties and good cold stamping formability, puncture resistance, electrolyte stability, and electrical insulation.

In some embodiments, the first anti-corrosion layer includes one or more of polypropylene, polyphenylene sulfide, polyphthalamide, and polyethylene; or

the first anti-corrosion layer is a layered structure, and at least a layer of the first anti-corrosion layer close to the medium flow channel includes one or more of polypropylene, polyphenylene sulfide, polyphthalamide, and polyethylene.

Here, polypropylene (Polypropylene, PP), polyphenylene sulfide (Polyphenylene sulfide, PPS), polyphthalamide (Polyphthalamide, PPA), or polyethylene (Polyethylene, PE) has good corrosion resistance, helping to reduce the possibility of corrosion and leakage of the heat exchange medium.

In some embodiments, the first anti-corrosion layer is formed on the rigid member by hot-pressing.

This manufacturing method is simple and cost-effective and is conducive to improving the connection reliability between the first anti-corrosion layer and the rigid member.

In some embodiments, the anti-corrosion layer includes a second anti-corrosion layer; and

a side of the rigid member facing away from the flexible member is provided with the second anti-corrosion layer.

The second anti-corrosion layer can reduce corrosion on the rigid member by external corrosive substances, thereby improving the reliability of the heat exchange assembly.

In some embodiments, a side of the flexible member facing away from the rigid member is provided with the second anti-corrosion layer.

In other words, the side of the flexible member facing away from the medium flow channel, that is, an outer side of the flexible member, is provided with the second anti-corrosion layer. The second anti-corrosion layer can reduce corrosion on the flexible member by external corrosive substances, thereby improving the reliability of the heat exchange assembly.

In some embodiments, a side edge of the heat exchange assembly is provided with the second anti-corrosion layer.

Thus, on one hand, the second anti-corrosion layer can reduce corrosion on the side edges of the flexible member and the rigid member by external corrosive substances. On the other hand, the second anti-corrosion layer can also reduce external corrosive substances infiltrating a gap between the flexible member and the rigid member from a connection position between the flexible member and the rigid member, further improving the reliability of the heat exchange assembly.

In some embodiments, the second anti-corrosion layer includes nylon.

Here, the second anti-corrosion layer may be a nylon layer formed of a nylon material, so that the second anti-corrosion layer has certain corrosion resistance, for example, resistance to acid and alkali corrosion.

In some embodiments, one of the flexible member and the rigid member forms a flange portion, and the flange portion at least covers a side edge of the other one.

In these embodiments, the flange portion is formed, and the flange portion at least covers the side edge of the other one, further reducing external corrosive substances infiltrating the gap between the flexible member and the rigid member from the connection position between the flexible member and the rigid member, thereby further improving the reliability of the heat exchange assembly.

In some embodiments, the flexible member includes a metal-plastic composite film.

In these embodiments, the metal-plastic composite film has a small thickness and low weight, and the medium flow channel is formed between the metal-plastic composite film and the heat exchange member, so that the influence of an extrusion process is avoided, and the requirement for a large thickness does not need to be met. Therefore, the overall thickness and weight of the heat exchange assembly can be reduced. Additionally, the insulating properties of the heat exchange assembly can reduce the possibility of insulation failure. This reduces the risk of reaction between the heat exchange assembly and the heat exchange medium flowing inside, further reducing the possibility of corrosion and leakage of the heat exchange medium.

In some embodiments, the flexible member includes an aluminum-plastic film.

The aluminum-plastic film exhibits high barrier properties and good cold stamping formability, puncture resistance, electrolyte stability, and electrical insulation.

In some embodiments, the flexible member is a layered structure, the flexible member includes a metal layer and a non-metal layer, and the metal layer and the non-metal layer are sequentially stacked.

In these embodiments, the flexible member including the metal layer and the non-metal layer sequentially stacked has a small thickness and low weight, and the medium flow channel is formed between the flexible member and the rigid member, so that the influence of an extrusion process is avoided, and the requirement for a large thickness does not need to be met. Therefore, the overall thickness and weight of the heat exchange assembly can be reduced. Additionally, the heat exchange assembly does not react with the heat exchange medium flowing inside, thereby eliminating the possibility of corrosion and leakage.

In some embodiments, the metal layer includes one or more of aluminum foil, copper foil, and steel foil.

Configuring the metal layer to include one or more of aluminum foil, copper foil, and steel foil allows the flexible member to have certain structural strength and provide isolation.

In some embodiments, the non-metal layer includes one or more of polypropylene, polyphenylene sulfide, polyphthalamide, and polyethylene.

Configuring the non-metal layer to include one or more of polypropylene, polyphenylene sulfide, polyphthalamide, and polyethylene allows the flexible member to have a certain waterproof effect.

In some embodiments, the non-metal layer is a hot-melt layer.

Here, configuring the non-metal layer as the hot-melt layer, that is, configuring the non-metal layer to be made of a hot-melt material, allows the non-metal layer to be easily compounded with the metal layer through hot-melting, thereby allowing for simple formation and high production efficiency.

In some embodiments, the flexible member is a layered structure, the flexible member includes a first anti-corrosion layer, an isolation layer, and a second anti-corrosion layer sequentially arranged, and the first anti-corrosion layer is closer to the medium flow channel than the second anti-corrosion layer.

In these embodiments, the flexible member is configured to include the first anti-corrosion layer, the isolation layer, and the second anti-corrosion layer sequentially arranged, and the first anti-corrosion layer is closer to the medium flow channel than the second anti-corrosion layer. This is conducive to improving the reliability of the heat exchange assembly.

In some embodiments, a thickness of the flexible member ranges from 0.05 mm to 0.3 mm.

In these embodiments, setting the thickness of the flexible member to range from 0.05 mm to 0.3 mm allows the heat exchange assembly made from the flexible member to have certain structural strength and allows the heat exchange assembly to have a small overall thickness, helping to reduce the overall volume and weight of the battery apparatus, thereby increasing the energy density of the battery apparatus.

In some embodiments, the thickness of the flexible member ranges from 0.08 mm to 0.2 mm.

In these embodiments, setting the thickness of the flexible member to range from 0.08 mm to 0.2 mm allows the heat exchange assembly made from the flexible member to have certain structural strength and further allows the heat exchange assembly to have a small overall thickness, helping to further reduce the overall volume and weight of the battery apparatus, thereby further increasing the energy density of the battery apparatus.

In some embodiments, an elastic modulus of at least a partial region of the flexible member is less than an elastic modulus of the rigid member.

Configuring the heat exchange assembly to include the flexible member and the rigid member allows the heat exchange assembly to have flexibility and also allows the heat exchange assembly to have certain structural strength.

The flexibility of the heat exchange assembly allows a heat exchange surface of the heat exchange assembly to better fit the battery cells, further improving the heat exchange efficiency and heat exchange effect of the heat exchange assembly.

In some embodiments, an elastic modulus of the flexible member ranges from 0.1 MPa to 10000 MPa.

In these embodiments, setting the elastic modulus of the flexible member to range from 0.1 MPa to 10000 MPa allows the flexible member to have certain structural strength, improves the reliability of the heat exchange assembly, and allows the flexible member to have certain deformability, improving the fit between the heat exchange assembly and the casing and/or the battery cells, thereby increasing the effective heat exchange area between the heat exchange assembly and the casing and/or the battery cells, and improving the heat exchange efficiency and heat exchange effect of the heat exchange assembly.

In some embodiments, the rigid member is configured as a metal plate.

In these embodiments, the rigid member is configured as the metal plate, and the metal plate has both high structural strength and high thermal conductivity. In other words, this allows the heat exchange assembly to have certain heat exchange efficiency and also allows the rigid member to provide a certain support effect for the flexible member.

A second aspect of embodiments of the present disclosure provides a heat exchange assembly, where the heat exchange assembly includes at least two heat exchange members, at least one of the heat exchange members is configured as a flexible member, at least one of the heat exchange members is configured as a rigid member, the flexible member and the rigid member are stacked to form at least one medium flow channel, the at least one medium flow channel is configured to conduct a heat exchange medium, and the heat exchange medium is configured to exchange heat with a plurality of battery cells;

where at least one of the flexible member and the rigid member includes an anti-corrosion layer.

The heat exchange assembly provided by the embodiments of the present disclosure is configured to exchange heat with the battery cells. On one hand, at least one heat exchange member is configured as the flexible member, and the flexible member is lightweight. This is conducive to reducing the mass of the heat exchange assembly, lowering production costs of the heat exchange assembly, and reducing the mass of the battery apparatus. Additionally, the flexible member has a specified flexibility, so that the heat exchange assembly can better fit the casing and/or the battery cells, thereby facilitating the absorption of assembly tolerances of the heat exchange assembly without requiring sealants or thermally conductive materials, improving the fit between the heat exchange assembly and the casing and/or the battery cells, increasing an effective heat exchange area between the heat exchange assembly and the casing and/or the battery cells, and improving the heat exchange efficiency and heat exchange effect of the heat exchange assembly. On the other hand, configuring at least one heat exchange member as the rigid member, where the flexible member and the rigid member are stacked to form at least one medium flow channel, allows the rigid member to provide a support effect for the flexible member, which is conducive to improving the overall structural strength and stability of the heat exchange assembly, further improving the heat exchange efficiency and heat exchange effect of the heat exchange assembly. Moreover, providing the rigid member allows the heat exchange assembly to have sufficient structural strength to support the battery cells, thereby improving the applicability of the heat exchange assembly. On yet another hand, at least one of the flexible member and the rigid member is configured to include the anti-corrosion layer. The provision of the anti-corrosion layer is conducive to improving the corrosion resistance of the heat exchange assembly, mitigating the issue of corrosion on the heat exchange assembly caused by the heat exchange medium and external corrosive substances, thereby improving the reliability of the heat exchange assembly.

A third aspect of embodiments of the present disclosure provides an electric apparatus including the battery apparatus described above or the heat exchange assembly described above.

The battery apparatus of the electric apparatus provided by the embodiments of the present disclosure includes a casing, a heat exchange assembly, and a plurality of battery cells, where the plurality of battery cells are disposed within the casing, and the casing provides protection to the battery cells. The heat exchange assembly is configured to exchange heat with the battery cells. On one hand, at least one heat exchange member is configured as the flexible member, and the flexible member is lightweight. This is conducive to reducing the mass of the heat exchange assembly, lowering production costs of the heat exchange assembly, and reducing the mass of the battery apparatus. Additionally, the flexible member has a specified flexibility, so that the heat exchange assembly can better fit the casing and/or the battery cells, thereby facilitating the absorption of assembly tolerances of the heat exchange assembly without requiring sealants or thermally conductive materials, improving the fit between the heat exchange assembly and the casing and/or the battery cells, increasing an effective heat exchange area between the heat exchange assembly and the casing and/or the battery cells, and improving the heat exchange efficiency and heat exchange effect of the heat exchange assembly. On the other hand, configuring at least one heat exchange member as the rigid member, where the flexible member and the rigid member are stacked to form at least one medium flow channel, allows the rigid member to provide a support effect for the flexible member, which is conducive to improving the overall structural strength and stability of the heat exchange assembly, further improving the heat exchange efficiency and heat exchange effect of the heat exchange assembly. Moreover, providing the rigid member allows the heat exchange assembly to have sufficient structural strength to support the battery cells, thereby improving the applicability of the heat exchange assembly. On yet another hand, at least one of the flexible member and the rigid member is configured to include the anti-corrosion layer. The provision of the anti-corrosion layer is conducive to improving the corrosion resistance of the heat exchange assembly, mitigating the issue of corrosion on the heat exchange assembly caused by the heat exchange medium and external corrosive substances, thereby improving the reliability of the heat exchange assembly.

### BRIEF DESCRIPTION OF DRAWINGS

FIG. 1 shows a schematic structural diagram of a vehicle according to an embodiment of the present disclosure;

FIG. 2 shows a three-dimensional schematic exploded view of a battery apparatus according to an embodiment of the present disclosure;

FIG. 3 shows a three-dimensional schematic exploded view of a heat exchange assembly according to an embodiment of the present disclosure;

FIG. 4 shows a three-dimensional schematic exploded view of a flexible member according to an embodiment of the present disclosure;

FIG. 5 shows a three-dimensional schematic exploded view of a heat exchange assembly according to an embodiment of the present disclosure; and

FIG. 6 shows a schematic structural diagram of a heat exchange assembly according to an embodiment of the present disclosure.

### DESCRIPTION OF REFERENCE SIGNS

10. battery cell; 20. casing; 21. casing body; 211. first casing portion; 212. second casing portion; 22. bottom guard plate; 23. accommodating cavity; 30. heat exchange assembly; 31. flexible member; 311. hot-pressed region; 312. medium flow channel; 313. first anti-corrosion layer; 314. isolation layer; 315. second anti-corrosion layer; 316. reinforcing portion; 317. flexible portion; 32. rigid member; 34. connecting member; 100. battery apparatus; 200. controller; 300. motor; and 1000. vehicle.

### DESCRIPTION OF EMBODIMENTS

Unless otherwise specified, all embodiments and optional embodiments of the present disclosure can be combined with each other to form new technical solutions.

Unless otherwise specified, all technical features and optional technical features of the present disclosure can be combined with each other to form new technical solutions.

With the development of clean energy, an increasing number of devices utilize electrical energy as drive energy, leading to the rapid development of traction batteries capable of storing significant electrical energy and supporting multiple charge-discharge cycles, such as lithium-ion batteries. Traction batteries have been not only used in energy storage power systems such as hydroelectric power plants, thermal power plants, wind power plants, and solar power plants, but are also widely used in many other fields including electric transportation tools such as electric bicycles, electric motorcycles, and electric vehicles, and aerospace.

In embodiments of the present disclosure, a battery cell may be a secondary battery, where the secondary battery refers to a battery cell that can be recharged to activate active materials for continued use after discharge.

The battery cell may be a lithium-ion battery, a sodium-ion battery, a sodium-lithium-ion battery, a lithium metal battery, a sodium metal battery, a lithium-sulfur battery, a magnesium-ion battery, a nickel-hydrogen battery, a nickel-cadmium battery, a lead-acid battery, or the like. This is not limited in the embodiments of the present disclosure.

The battery cell typically includes an electrode assembly. The electrode assembly includes a positive electrode, a negative electrode, and a separator, where the separator is disposed between the negative electrode and the positive electrode. During charging and discharging of the battery cell, active ions (such as lithium ions) intercalate and deintercalate back and forth between the positive electrode and the negative electrode. The separator is disposed between the positive electrode and the negative electrode to prevent short circuits between the positive electrode and the negative electrode and to allow the active ions to pass through.

The electrode assembly may be a wound structure, a laminated structure, or a hybrid structure combining wound and laminated configurations.

In some embodiments, the electrode assembly is a wound structure. A positive electrode plate and a negative electrode plate are wound into a wound structure.

In some embodiments, the electrode assembly is a laminated structure.

As an example, a plurality of positive electrode plates and a plurality of negative electrode plates may be provided, and the plurality of positive electrode plates and the plurality of negative electrode plates are alternately stacked.

As an example, a plurality of positive electrode plates may be provided, and a negative electrode plate is folded to form a plurality of stacked folding segments, with a positive electrode plate clamped between adjacent folding segments.

As an example, both the positive electrode plate and the negative electrode plate are folded to form a plurality of stacked folding segments.

As an example, a plurality of separators may be provided, which are respectively disposed between any adjacent positive electrode plates or negative electrode plates.

As an example, separators may be continuously disposed, which are disposed between any adjacent positive electrode plates or negative electrode plates through folding or winding.

In some embodiments, the electrode assembly may have a cylindrical shape, a flat shape, or a polyhedral shape.

In some embodiments, the electrode assembly is provided with tabs, where the tabs can conduct current from the electrode assembly. The tabs include a positive tab and a negative tab.

In some embodiments, the battery cell may include a housing. The housing may be a steel housing, an aluminum housing, a plastic housing (for example, polypropylene), a composite metal housing (for example, a copper-aluminum composite housing), an aluminum-plastic film, or the like. In some embodiments, the housing may be a sealed structure or a non-sealed structure. As an example, when the housing is a non-sealed structure, the housing protects the electrode assembly, and a sealing bag is further included between the housing and the electrode assembly, where the sealing bag is configured to encapsulate the electrode assembly and an electrolyte. Specifically, the sealing bag may be a bag-shaped insulating member or an aluminum-plastic film. When the housing is a sealed structure, the housing is configured to encapsulate components such as the electrode assembly and the electrolyte.

As an example, the battery cell may be a cylindrical battery cell, a prismatic battery cell, a pouch battery cell, or a battery cell of another shape. The prismatic battery cell includes a square-shell battery cell, a blade-shaped battery cell, or a polyhedral battery cell, where the polyhedral battery is, for example, a hexagonal prismatic battery. This is not particularly limited in the present disclosure.

In some embodiments, the housing includes an end cover and a housing body, where the housing body is provided with an opening, and the end cover covers the opening. The housing body may be provided with one or more openings. One or more end covers may be provided.

In some embodiments, the housing is provided with at least one electrode terminal, where the electrode terminal is electrically connected to a tab. The electrode terminal may be directly connected to the tab or indirectly connected to the tab via a current collector. The electrode terminal may be disposed on the end cover or on the housing body.

In some embodiments, an energy storage device includes an energy storage container, an energy storage cabinet, and the like.

The demand for an area energy density in an energy storage container for a power plant is increasing. Therefore, to increase electrical capacity, the weight of the container also increases correspondingly. However, the container needs to be transported from a production site to a usage site via land and/or sea. Typically, there are weight limits for land and sea transportation, so there is a conflict between the increase in the energy density and the weight of the energy storage container.

During use of the battery apparatus, battery cells within the battery apparatus generate heat. Excessive heat can adversely affect the performance and service life of the battery apparatus. Consequently, how to effectively dissipate heat from the battery cells of the battery apparatus and reduce the weight of the heat exchange assembly has become a significant research focus in this field. In related art, a cooling system is disposed within a casing of the battery apparatus to cool the battery cells in the battery apparatus. The cooling system may include a plurality of aluminum water-cooling plates laid within the casing of the battery apparatus, where surfaces of the plurality of water-cooling plates are in contact with surfaces of the battery cells in the battery apparatus. During use, a heat exchange medium, such as water, flows through the plurality of water-cooling plates to take away heat from the battery cells and cool the battery cells. However, the aluminum water-cooling plates in the cooling system are heavy and susceptible to corrosion.

In view of this, to mitigate the issue of corrosion on the heat exchange assembly, embodiments of the present disclosure provide a battery apparatus, where the battery apparatus includes a casing, a heat exchange assembly, and a plurality of battery cells. The plurality of battery cells are disposed within the casing. The heat exchange assembly includes at least two heat exchange members, where at least one heat exchange member is configured as a flexible member, and at least one heat exchange member is configured as a rigid member. The flexible member and the rigid member are stacked to form at least one medium flow channel. The at least one medium flow channel is configured to conduct a heat exchange medium, where the heat exchange medium is configured to exchange heat with the plurality of battery cells. At least one of the flexible member and the rigid member includes an anti-corrosion layer.

The battery apparatus provided by the embodiments of the present disclosure includes the casing, the heat exchange assembly, and the plurality of battery cells, where the plurality of battery cells are disposed within the casing, and the casing provides protection to the battery cells. The heat exchange assembly is configured to exchange heat with the battery cells. On one hand, at least one heat exchange member is configured as the flexible member, and the flexible member is lightweight. This is conducive to reducing the mass of the heat exchange assembly, lowering production costs of the heat exchange assembly, and reducing the mass of the battery apparatus. Additionally, the flexible member has a specified flexibility, so that the heat exchange assembly can better fit the casing and/or the battery cells, thereby facilitating the absorption of assembly tolerances of the heat exchange assembly without requiring sealants or thermally conductive materials, improving the fit between the heat exchange assembly and the casing and/or the battery cells, increasing an effective heat exchange area between the heat exchange assembly and the casing and/or the battery cells, and improving the heat exchange efficiency and heat exchange effect of the heat exchange assembly. On the other hand, configuring at least one heat exchange member as the rigid member, where the flexible member and the rigid member are stacked to form at least one medium flow channel, allows the rigid member to provide a support effect for the flexible member, which is conducive to improving the overall structural strength and stability of the heat exchange assembly, further improving the heat exchange efficiency and heat exchange effect of the heat exchange assembly. Moreover, providing the rigid member allows the heat exchange assembly to have sufficient structural strength to support the battery cells, thereby improving the applicability of the heat exchange assembly. On yet another hand, at least one of the flexible member and the rigid member is configured to include the anti-corrosion layer. The provision of the anti-corrosion layer is conducive to improving the corrosion resistance of the heat exchange assembly, mitigating the issue of corrosion on the heat exchange assembly caused by the heat exchange medium and external corrosive substances, thereby improving the reliability of the heat exchange assembly.

The technical solutions described in the embodiments of the present disclosure are applicable to an electric apparatus using the battery apparatus. The electric apparatus includes the battery apparatus of any embodiment of the present disclosure, where the battery apparatus is configured to provide electrical energy.

The electric apparatus may be a vehicle, a mobile phone, a portable device, a laptop computer, a ship, a spacecraft, an electric toy, an electric tool, or the like. The vehicle may be a fossil fuel vehicle, a natural gas vehicle, or a new energy vehicle. The new energy vehicle may be a battery electric vehicle, a hybrid electric vehicle, a range-extended electric vehicle, or the like. The spacecraft includes an airplane, a rocket, a space shuttle, a spaceship, and the like. The electric toy includes a fixed or mobile electric toy, such as a game console, an electric toy car, an electric toy ship, and an electric toy airplane. The electric tool includes an electric metal cutting tool, an electric grinding tool, an electric assembly tool, and an electric railway-specific tool, such as an electric drill, an electric grinder, an electric wrench, an electric screwdriver, an electric hammer, an electric impact drill, a concrete vibrator, and an electric planer. The electric apparatus described above is not particularly limited in the embodiments of the present disclosure.

It should be noted that the technical solutions described in the embodiments of the present disclosure are not only applicable to the battery apparatus described above but also applicable to all electric apparatuses and energy storage devices including the battery apparatus. However, for brevity, the following embodiments are described using an electric vehicle as an example.

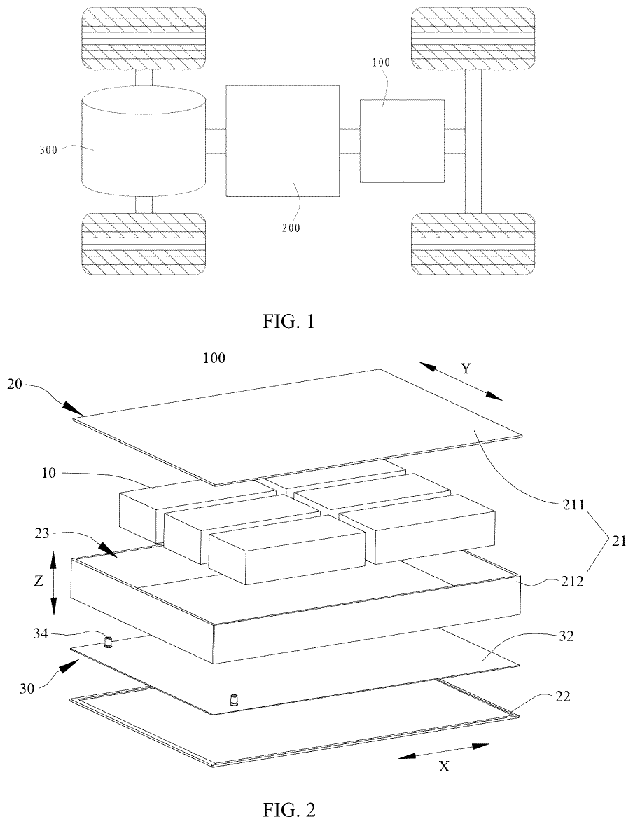

Referring to FIG. 1, a vehicle 1000 may be internally provided with a controller 200, a motor 300, and a battery apparatus 100, where the controller 200 is configured to control the battery apparatus 100 to supply power to the motor 300. For example, the battery apparatus 100 may be disposed at the bottom, front, or rear of the vehicle 1000. The battery apparatus 100 may be configured to supply power to the vehicle 1000. For example, the battery apparatus 100 can be used as an operational power source for the vehicle 1000 which is configured for a circuit system of the vehicle 1000, for example, to satisfy power needs of start, navigation, and running of the vehicle 1000. In another embodiment of the present disclosure, the battery apparatus 100 can not only serve as an operational power source for the vehicle 1000 but also as a driving power source for the vehicle 1000, replacing or partially replacing fossil fuel or natural gas to provide driving traction for the vehicle 1000.

Referring to FIG. 2, to meet different power demands, the battery apparatus 100 includes a plurality of battery cells 10, where a battery cell 10 is the smallest unit constituting a battery module or a battery pack. The plurality of battery cells 10 may be connected in series, parallel, or series-parallel, where being connected in series-parallel means a combination of series and parallel connections of the plurality of battery cells 10. The plurality of battery cells 10 may be directly connected in series, parallel, or series-parallel, and then an entirety formed by the plurality of battery cells 10 is accommodated within a casing 20. Alternatively, the battery apparatus 100 may include a plurality of battery cells 10 first connected in series, parallel, or series-parallel to form a battery module, and then a plurality of battery modules are connected in series, parallel, or series-parallel to form an entirety which is accommodated within the casing 20. The battery apparatus 100 may further include other structures. For example, the battery apparatus 100 may further include a busbar component configured to achieve electrical connections between the plurality of battery cells 10. Each battery cell 10 may be a secondary battery or a primary battery and may alternatively be a lithium-sulfur battery, a sodium-ion battery, or a magnesium-ion battery, but is not limited thereto. The battery cell 10 may have a cylindrical shape, a flat shape, a rectangular shape, or other shapes.

Referring to FIGS. 2 to 6, embodiments of the present disclosure provide a battery apparatus 100, where the battery apparatus 100 includes a casing 20, a heat exchange assembly 30, and a plurality of battery cells 10. The plurality of battery cells 10 are disposed within the casing 20. The heat exchange assembly 30 includes at least two heat exchange members, where at least one heat exchange member is configured as a flexible member 31, and at least one heat exchange member is configured as a rigid member 32. The flexible member 31 and the rigid member 32 are stacked to form at least one medium flow channel 312. The at least one medium flow channel 312 is configured to conduct a heat exchange medium, where the heat exchange medium is configured to exchange heat with the plurality of battery cells 10. At least one of the flexible member 31 and the rigid member 32 includes an anti-corrosion layer.

The term “a plurality of” in the embodiments of the present disclosure refers to a quantity of two or more.

Referring to FIG. 2, the battery apparatus 100 includes the casing 20 and a plurality of battery cells 10, where the plurality of battery cells 10 are disposed within the casing 20.

The casing 20 may be a simple three-dimensional structure such as a single cuboid, cylinder, or sphere, or a complex three-dimensional structure formed by combining simple three-dimensional structures such as cuboids, cylinders, or spheres. The material of the casing 20 may be an alloy material such as aluminum alloy or iron alloy, a polymer material such as polycarbonate or polyisocyanurate foam plastic, or a composite material such as glass fiber reinforced with epoxy resin.

The casing 20 is configured to encapsulate the battery cells 10, and the casing 20 can prevent liquids or other foreign objects from affecting the charging or discharging of the battery cells 10.

For example, the casing 20 is typically a cuboid structure, where a length direction and a width direction of the casing 20 are both parallel to the horizontal plane, and the length direction of the casing 20 is parallel to the longest edge of the cuboid structure of the casing 20. A height direction of the casing 20 is perpendicular to the ground. For example, as shown in FIG. 2, the length direction of the casing 20 is denoted as X, the width direction of the casing 20 is denoted as Y, and the height direction of the casing 20 is denoted as Z.

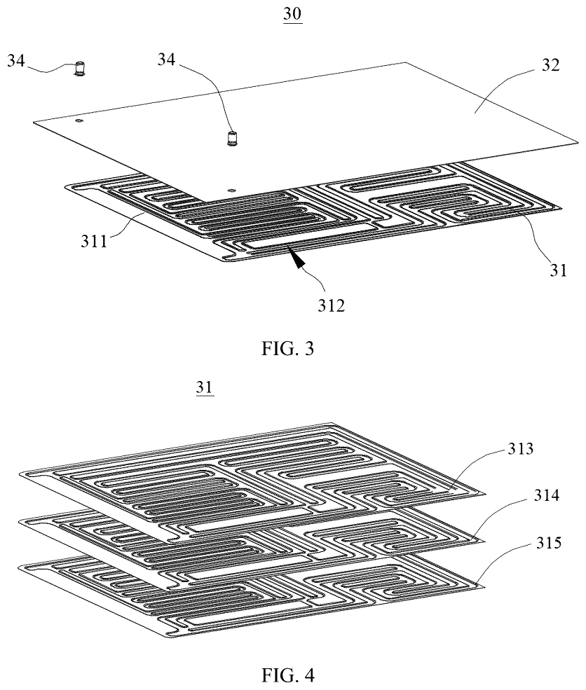

Referring to FIGS. 3 to 6, embodiments of the present disclosure provide a heat exchange assembly 30. The heat exchange assembly 30 includes at least two heat exchange members, where at least one heat exchange member is configured as a flexible member 31, and at least one heat exchange member is configured as a rigid member 32. The flexible member 31 and the rigid member 32 are stacked to form at least one medium flow channel 312, where the at least one medium flow channel 312 is configured to conduct a heat exchange medium, and the heat exchange medium is configured to exchange heat with the plurality of battery cells 10. At least one of the flexible member 31 and the rigid member 32 includes an anti-corrosion layer.

Here, the flexibility of the flexible member 31 refers to a material property of the structure. The property of this type may be a property attributed to the material due to the light mass of the material or a property attributed to the material due to at least any property such as the thickness, stiffness, strength, or elastic modulus of the material. As an example, the material of the flexible member 31 can select a material with a mass lighter than that of a structure such as a conventional aluminum plate or steel plate. The flexibility of the flexible member 31 can be controlled by the thickness, width, length, or type of the material of the flexible member 31. In the embodiments of the present disclosure, configuring the heat exchange assembly 30 to be a form including the flexible member 31 is conducive to reducing the weight of the heat exchange assembly 30.

Here, the rigidity of the rigid member 32 refers to a material property of the structure. The property of this type may be a property attributed to the material due to the light mass of the material or a property attributed to the material due to at least any property such as the thickness, stiffness, strength, or elastic modulus of the material. As an example, the material of the rigid member 32 can select a metal plate such as a conventional aluminum plate or steel plate, or a material plate of a structure such as a composite plate. The rigidity of the rigid member 32 can be controlled by the thickness, width, length, or type of material of the rigid member 32. In the embodiments of the present disclosure, configuring the heat exchange assembly 30 to be a form including the rigid member 32 can provide support to the flexible member 31 and is conducive to improving the overall structural strength and stability of the heat exchange assembly 30.

For example, an elastic modulus of at least a partial region of the flexible member 31 is less than an elastic modulus of the rigid member 32.

Here, an elastic modulus of a partial region of the flexible member 31 may be less than the elastic modulus of the rigid member 32, or an elastic modulus of an entire region of the flexible member 31 may be less than the elastic modulus of the rigid member 32.

Configuring the heat exchange assembly 30 to include the flexible member 31 and the rigid member 32 allows the heat exchange assembly 30 to have flexibility and also allows the heat exchange assembly 30 to have certain structural strength.

The flexibility of the heat exchange assembly 30 allows a heat exchange surface of the heat exchange assembly 30 to better fit the battery cells 10, further improving the heat exchange efficiency and heat exchange effect of the heat exchange assembly 30.

The flexible member 31 and the rigid member 32 being stacked to form at least one medium flow channel 312 means that the heat exchange assembly 30 forms the medium flow channel 312 between the flexible member 31 and the rigid member 32. In other words, the flexible member 31 constitutes at least a portion of a sidewall of the medium flow channel 312, and the rigid member 32 also constitutes at least a portion of the sidewall of the medium flow channel 312. The heat exchange medium flows in the medium flow channel 312 to exchange heat with the battery cells 10.

It should be noted that the specific type of the heat exchange medium is not limited herein, provided that it can achieve a heat exchange effect with the battery cells 10. For example, the heat exchange medium may be gaseous or liquid. In the embodiments of the present disclosure, the heat exchange medium is described as a coolant for illustrative purposes.

It should be noted that the specific number of the medium flow channels 312 is not limited herein. One or more medium flow channels 312 may be provided.

The heat exchange assembly 30 includes at least two heat exchange members, that is, a plurality of heat exchange members are provided.

At least one heat exchange member being configured as the flexible member 31 means that one or more flexible members 31 are provided. In embodiments where a plurality of heat exchange members are configured as flexible members 31, the flexible members 31 may be identical or different.

At least one heat exchange member being configured as the rigid member 32 means that one or more rigid members 32 are provided. In embodiments where a plurality of heat exchange members are configured as rigid members 32, the rigid members 32 may be identical or different.

For example, the heat exchange assembly 30 includes two heat exchange members, one being the flexible member 31 and the other being the rigid member 32.

For example, the rigid member 32 is a rigid plate-like structure capable of supporting the flexible member 31, thereby helping to improve the overall structural strength and stability of the heat exchange assembly 30.

For example, the rigid member 32 may alternatively be stamped or welded to form a specific structure for support or other purposes as needed.

For example, the heat exchange assembly 30 further includes an inlet and an outlet, where both the inlet and the outlet are in communication with the medium flow channel 312.

Here, the inlet and outlet of the heat exchange assembly 30 are configured to be connected to pipelines of liquid storage apparatuses such as air conditioning systems or water tanks of vehicles or electric apparatuses.

For example, referring to FIG. 3, the heat exchange assembly 30 further includes a connecting member 34 having an inlet and a connecting member 34 having an outlet, where the connecting member 34 is connected to the rigid member 32.

For example, the connecting member 34 is connected to the rigid member 32 by brazing.

For example, the connecting member 34 is, for example, a water nozzle.

The principle of the heat exchange assembly 30 exchanging heat with the battery cells 10 is as follows: A heat exchange medium output from a heat exchange medium source (not shown in the figure) enters the medium flow channel 312 through the inlet of the heat exchange assembly 30; and after the heat exchange medium exchanges heat with the battery cells 10, the heat exchange medium flows out through the outlet of the heat exchange assembly 30 to complete the heat exchange with the battery cells 10.

Here, the heat exchange performed by the heat exchange assembly 30 with the battery cells 10 can involve dissipating heat from the battery cells 10 or heating the battery cells 10.

The principle of the heat exchange assembly 30 dissipating heat from the battery cells 10 is as follows: A heat exchange medium output from the heat exchange medium source enters the medium flow channel 312 through the inlet of the heat exchange assembly 30; and after the heat exchange medium absorbs heat generated by the battery cells 10 during operation, the heat exchange medium flows out through the outlet of the heat exchange assembly 30 to release the heat and complete the cooling and heat dissipation of the battery cells 10.

The principle of the heat exchange assembly 30 heating the battery cells 10 is as follows: A heat exchange medium output from a heat exchange medium source enters the medium flow channel 312 through the inlet of the heat exchange assembly 30; and after the heat exchange medium transfers heat to the battery cells 10 to heat the battery cells 10, the heat exchange medium flows out through the outlet of the heat exchange assembly 30 to complete the heating of the battery cells 10.

The flexible member 31 is configured as a flexible structure, and the flexible member 31 has certain expandable or contractible properties. It can alternatively be understood that the flexible member 31 may be an elastically deformable structure, and the flexible member 31 has the capability of deforming and recovering its shape. This allows the heat exchange assembly 30 to form a conformal structure, so that the heat exchange assembly 30 can better match external contour shapes of the battery cells 10 or other components, thereby improving the fit between the heat exchange assembly 30 and the casing 20 and/or the battery cells 10, increasing an effective heat exchange area between the heat exchange assembly 30 and the casing 20 and/or the battery cells 10, and improving the heat exchange efficiency.

It should be noted that the flexible member 31 may have conductivity, facilitating equipotential bonding with the casing 20. The flexible member 31 can alternatively have electrical insulation properties, eliminating the need for insulation treatment and helping to reduce the risk of electrical leakage and production costs of the battery apparatus 100, thereby improving the reliability of the battery apparatus 100.

It should be noted that the specific arrangement position of the heat exchange assembly 30 is not limited herein.

For example, in some embodiments, referring to FIG. 2, the casing 20 and the heat exchange assembly 30 enclose to form an accommodating cavity 23, and the battery cells 10 are disposed within the accommodating cavity 23.

In other words, the heat exchange assembly 30 constitutes a cavity wall of the accommodating cavity 23. This is conducive to reducing the materials used of the casing 20 and is further conducive to reducing the weight of the battery apparatus 100 and reducing the cost of the battery apparatus 100. Additionally, this also allows the heat exchange assembly 30 to be in direct contact with the battery cells 10, further improving the heat exchange efficiency between the heat exchange assembly 30 and the battery cells 10.

For example, the heat exchange assembly 30 constitutes a bottom wall of the accommodating cavity 23, and the battery cells 10 are supported on the heat exchange assembly 30.

Here, the flexible member 31 may be disposed on a side of the rigid member 32 facing the battery cells 10 or on a side of the rigid member 32 facing away from the battery cells 10.

For example, the rigid member 32 is connected to the casing 20 by welding or screwing.

In some other embodiments, the heat exchange assembly 30 may be disposed within the casing 20, that is, the heat exchange assembly 30 is in direct contact with the battery cells 10. Alternatively, the heat exchange assembly 30 may be disposed outside the casing 20, that is, the casing 20 is provided with an accommodating cavity 23, and the heat exchange assembly 30 is disposed outside the accommodating cavity 23. Heat is transferred through an intermediate medium to achieve heat exchange between the heat exchange assembly 30 and the battery cells 10.

That is, at least a portion of the heat exchange assembly 30 is disposed on an outer side of the casing 20 to separate the heat exchange assembly 30 from the battery cells 10.

The casing 20 is configured to accommodate the battery cells 10, and the casing 20 may have various structures. In some embodiments, still referring to FIG. 2, the casing 20 includes a casing body 21, where the casing body 21 may include a first casing portion 211 and a second casing portion 212; the first casing portion 211 and the second casing portion 212 fit each other; and the first casing portion 211, the second casing portion 212, and the heat exchange assembly 30 together define an accommodating space for accommodating the battery cells 10.

For example, the second casing portion 212 may be a frame structure with openings at both ends; the first casing portion 211 is a plate-like structure, and the first casing portion 211 covers an opening at one end of the second casing portion 212; and the heat exchange assembly 30 is disposed at an opening at the other end of the second casing portion 212 to form the accommodating cavity 23.

The first casing portion 211 and the second casing portion 212 may alternatively each be a hollow structure with an opening on one side; an opening side of the first casing portion 211 is engaged with an opening side of the second casing portion 212 to form a casing body 21 with an accommodating space. Certainly, the first casing portion 211 and the second casing portion 212 may have various shapes, for example, cylinder or cuboid.

To improve airtightness after connection of the first casing portion 211 and the second casing portion 212, a sealing member, for example, a sealing adhesive or a sealing ring, may alternatively be disposed between the first casing portion 211 and the second casing portion 212.

Assuming that the first casing portion 211 covers a top of the second casing portion 212, the first casing portion 211 may also be referred to as an upper casing cover, and the second casing portion 212 may also be referred to as a lower casing cover.

For example, still referring to FIG. 2, the battery apparatus 100 further includes a bottom guard plate 22, where the bottom guard plate 22 is disposed on a side of the heat exchange assembly 30 facing away from the battery cells 10.

Here, the bottom guard plate 22 is disposed on the side of the heat exchange assembly 30 facing away from the battery cells 10 to protect the heat exchange assembly 30 and the casing 20, reducing the impact of external debris on the casing 20 during running of a vehicle, thereby improving the reliability of the battery apparatus 100.

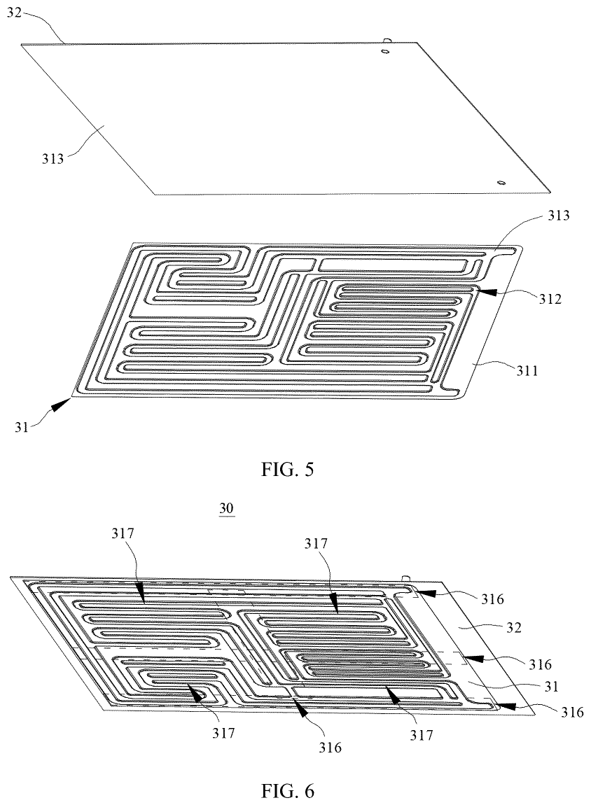

In some embodiments, referring to FIGS. 5 and 6, the flexible member 31 and the rigid member 32 are hot-pressed to form a hot-pressed region 311 and a medium flow channel 312, and the flexible member 31 and the rigid member 32 are connected to each other in at least a partial region of the hot-pressed region 311.

In other words, the flexible member 31 and the rigid member 32 are connected to each other through hot-pressing, and the hot-pressed region 311 and the medium flow channel 312 are formed through hot-pressing. A flow channel region is configured to conduct the heat exchange medium. This forming method is simple.

Here, the flexible member 31 is sealed by a hot-pressing process. The hot-pressing process can effectively ensure that the heat exchange assembly 30 has good airtightness and is less likely to crack.

In these embodiments, the flexible member 31 is sealed through the hot-pressing process, that is, the hot-pressed region 311 is formed through hot-pressing. The hot-pressed region 311 divides the heat exchange assembly 30 to form at least one medium flow channel 312. This forming method is simple.

For example, the hot-pressed region 311 includes a heat-sealed zone and a non-heat-sealed zone, and the non-heat-sealed zone and the medium flow channel 312 are respectively located on two sides of the heat-sealed zone. This is conducive to reducing the width of the heat-sealed zone and mitigating the issues of influence on hot-pressing quality and damage to the flexible member 31 caused by excessive temperature due to an excessively wide heat-sealed zone. Additionally, the non-heat-sealed zone can also form a stress relaxation buffer zone when the flexible member 31 is folded, reducing damage to the heat-sealed zone due to stress concentration in the heat-sealed zone.

In related art, a heat exchange assembly is formed by welding high-strength aluminum alloys, where high-strength aluminum alloys (such as 5-series or 6-series) have high alloy content, causing alloy elements to precipitate during welding, and affecting the welding quality.

In the embodiments of the present disclosure, the heat exchange assembly 30 is configured to include the flexible member 31 and the rigid member 32. The flexible member 31 and the rigid member 32 form the hot-pressed region 311 and the medium flow channel 312 through hot-pressing, where a hot-pressing temperature (150 °C±10 °C) is lower than the brazing temperature used in related art, and alloy elements do not precipitate. This is conducive to further improving the structural strength of the heat exchange assembly 30.

The flexible member 31 may include an anti-corrosion layer, the rigid member 32 may include an anti-corrosion layer, or the flexible member 31 and the rigid member 32 may each include an anti-corrosion layer.

Here, the provision of the anti-corrosion layer can mitigate the issue of corrosion on the heat exchange assembly 30 caused by the heat exchange medium and external corrosive substances.

The battery apparatus 100 provided by the embodiments of the present disclosure includes the casing 20, the heat exchange assembly 30, and the plurality of battery cells 10, where the plurality of battery cells 10 are disposed within the casing 20, and the casing 20 provides protection to the battery cells 10. The heat exchange assembly 30 is configured to exchange heat with the battery cells 10. On one hand, at least one heat exchange member is configured as the flexible member 31, and the flexible member 31 is lightweight. This is conducive to reducing the mass of the heat exchange assembly 30, lowering production costs of the heat exchange assembly 30, and reducing the mass of the battery apparatus 100. Additionally, the flexible member 31 has a specified flexibility, so that the heat exchange assembly 30 can better fit the casing 20 and/or the battery cells 10, thereby facilitating the absorption of assembly tolerances of the heat exchange assembly 30 without requiring sealants or thermally conductive materials, improving the fit between the heat exchange assembly 30 and the casing 20 and/or the battery cells 10, increasing an effective heat exchange area between the heat exchange assembly 30 and the casing 20 and/or the battery cells 10, and improving the heat exchange efficiency and heat exchange effect of the heat exchange assembly 30. On the other hand, configuring at least one heat exchange member as the rigid member 32, where the flexible member 31 and the rigid member 32 are stacked to form at least one medium flow channel 312, allows the rigid member 32 to provide a support effect for the flexible member 31, which is conducive to improving the overall structural strength and stability of the heat exchange assembly 30, further improving the heat exchange efficiency and heat exchange effect of the heat exchange assembly 30. Moreover, providing the rigid member 32 allows the heat exchange assembly 30 to have sufficient structural strength to support the battery cells 10, thereby improving the applicability of the heat exchange assembly 30. On yet another hand, at least one of the flexible member 31 and the rigid member 32 is configured to include the anti-corrosion layer. The provision of the anti-corrosion layer is conducive to improving the corrosion resistance of the heat exchange assembly 30, mitigating the issue of corrosion on the heat exchange assembly caused by the heat exchange medium and external corrosive substances, thereby improving the reliability of the heat exchange assembly 30.

In some embodiments, referring to FIG. 6, the flexible member 31 includes a reinforcing portion 316 and a flexible portion 317, and an elastic modulus of the flexible portion 317 is less than an elastic modulus of the reinforcing portion 316.

For example, the reinforcing portion 316 is located at a dashed box of the flexible member 31. Certainly, in different embodiments, the flexible member 31 can form the reinforcing portion 316 at different positions as needed.

The elastic modulus of the flexible portion 317 being less than the elastic modulus of the reinforcing portion 316 means that the flexible member 31 includes regions with different elastic moduli. Thus, a partial region of the flexible member 31 can be configured as the reinforcing portion 316 as needed, so that an elastic modulus of this region is greater than the elastic modulus of the flexible portion 317, thereby allowing the flexible member 31 to have flexibility, reducing the weight of the flexible member 31, and helping to improve the overall structural strength and stability of the flexible member 31.

Here, the elastic modulus of the reinforcing portion 316 may be equal to the elastic modulus of the rigid member 32, less than the elastic modulus of the rigid member 32, or greater than the elastic modulus of the rigid member 32.

For example, one or more reinforcing portions 316 may be provided.

For example, one or more flexible portions 317 may be provided.

For example, a plurality of reinforcing portions 316 are provided, where the plurality of reinforcing portions 316 are spaced apart and/or alternately arranged, and the flexible portion 317 is disposed between adjacent reinforcing portions 316, thereby improving the overall structural strength of the flexible member 31.

For example, at least some reinforcing portions 316 extend along the length direction of the casing 20.

For example, at least some reinforcing portions 316 extend along the width direction of the casing 20.

For example, some reinforcing portions 316 extend along the length direction of the casing 20, and the reinforcing portions 316 extending along the length direction of the casing 20 are spaced apart along the width direction of the casing 20, and some other reinforcing portions 316 extend along the width direction of the casing 20.

In some embodiments, referring to FIG. 6, at least some reinforcing portions 316 are disposed at an edge of the flexible member 31.

This configuration can further improve the overall structural strength and stability of the flexible member 31.

For example, the reinforcing portion 316 disposed at the edge of the flexible member 31 is connected to the rigid member 32.

In some embodiments, referring to FIG. 6, at least some medium flow channels 312 are formed in the flexible portion 317.

In other words, some medium flow channels 312 may be formed in the flexible portion 317, some medium flow channels 312 may alternatively be formed in the reinforcing portion 316, or all medium flow channels 312 may be formed in the flexible portion 317.

Here, at least some medium flow channels 312 are formed in the flexible portion 317. The flexibility of the flexible portion 317 allows for better contact between a heat exchange surface of the heat exchange assembly 30 and the battery cells 10, providing better heat exchange capability.

It can be understood that there are various ways to allow the elastic modulus of the flexible portion 317 to be less than the elastic modulus of the reinforcing portion 316.

In some embodiments, a thickness of the flexible portion 317 is less than a thickness of the reinforcing portion 316.

In other words, the flexible member 31 can be thinned in the flexible portion 317 to make the thickness of the flexible portion 317 less than the thickness of the reinforcing portion 316, thereby allowing the elastic modulus of the flexible portion 317 to be less than the elastic modulus of the reinforcing portion 316. This manufacturing method is simple.

For example, the flexible member 31 is a layered structure. The number of layers of the flexible member 31 in the flexible portion 317 is set to be less than the number of layers of the flexible member 31 in the reinforcing portion 316, thereby making the thickness of the flexible portion 317 less than the thickness of the reinforcing portion 316.

In some embodiments, a material of the flexible portion 317 is different from a material of the reinforcing portion 316.

In other words, the material of the flexible portion 317 is set to be different from the material of the reinforcing portion 316, thereby allowing the elastic modulus of the flexible portion 317 to be less than the elastic modulus of the reinforcing portion 316.

In some embodiments, referring to FIGS. 3 to 5, the anti-corrosion layer includes a first anti-corrosion layer 313, and the rigid member 32 is provided with the first anti-corrosion layer 313 in at least a region where the medium flow channel 312 is formed.

In other words, the first anti-corrosion layer 313 is provided in at least a region of the rigid member 32 in contact with the heat exchange medium. The first anti-corrosion layer 313 separates the heat exchange medium from the rigid member 32, thereby mitigating damage to the rigid member 32 by the heat exchange medium, that is, reducing corrosion and leakage of the heat exchange medium.

Here, the first anti-corrosion layer 313 is, for example, a heat exchange medium-resistant layer. For example, in embodiments where the heat exchange medium is water, the first anti-corrosion layer 313 may be a waterproof layer.

In these embodiments, the rigid member 32 is provided with the first anti-corrosion layer 313 in at least the region where the medium flow channel 312 is formed, and the first anti-corrosion layer 313 can mitigate damage to the rigid member 32 by the heat exchange medium, helping to improve the reliability of the heat exchange assembly 30.

Here, the rigid member 32 may be provided with the first anti-corrosion layer 313 in only the region where the medium flow channel 312 is formed. Alternatively, a side of the rigid member 32 facing the flexible member 31 may be covered with the first anti-corrosion layer 313, thereby further mitigating damage to the rigid member 32 by the heat exchange medium and further improving the reliability of the heat exchange assembly 30.

In some embodiments, the first anti-corrosion layer 313 is configured as a metal-plastic composite film.

The first anti-corrosion layer 313 may be a single-layer or multi-layer film.

Here, the metal-plastic composite film is a metal-plastic composite material, that is, including a metal layer and a plastic layer.

In these embodiments, the metal-plastic composite film has a small thickness and low weight, and a medium flow channel 312 is formed between the metal-plastic composite film and the flexible member 31, so that the influence of an extrusion process is avoided, and the requirement for a large thickness does not need to be met. Therefore, the overall thickness and weight of the heat exchange assembly 30 can be reduced. Additionally, the insulating properties of the heat exchange assembly 30 can reduce the possibility of insulation failure. This reduces the possibility of reaction between the rigid member 32 and the heat exchange medium flowing inside, further reducing the possibility of corrosion and leakage of the heat exchange medium.

In some embodiments, the first anti-corrosion layer 313 is configured as an aluminum-plastic film.

The aluminum-plastic film exhibits high barrier properties and good cold stamping formability, puncture resistance, electrolyte stability, and electrical insulation.

For example, the first anti-corrosion layer 313 includes one or more of polypropylene, polyphenylene sulfide, polyphthalamide, and polyethylene.

Here, polypropylene (Polypropylene, PP), polyphenylene sulfide (Polyphenylene sulfide, PPS), polyphthalamide (Polyphthalamide, PPA), or polyethylene (Polyethylene, PE) has good corrosion resistance, helping to reduce the possibility of corrosion and leakage of the heat exchange medium.

For example, the first anti-corrosion layer 313 is a layered structure, and at least a layer of the first anti-corrosion layer 313 close to the medium flow channel 312 includes one or more of polypropylene, polyphenylene sulfide, polyphthalamide, and polyethylene.

For example, the first anti-corrosion layer 313 is an anti-corrosion coating, and the anti-corrosion coating includes one or two of epoxy resin and polyester resin.

In some embodiments, the first anti-corrosion layer 313 is formed on the rigid member 32 by hot-pressing.

This manufacturing method is simple and cost-effective and is conducive to improving the connection reliability between the first anti-corrosion layer 313 and the rigid member 32.

For example, the flexible member 31 is provided with the first anti-corrosion layer 313.

Here, the flexible member 31 may be provided with the first anti-corrosion layer 313 in at least a region where the medium flow channel 312 is formed, or a side of the flexible member 31 facing the rigid member 32 may be covered with the first anti-corrosion layer 313.

In some embodiments, referring to FIG. 4, the anti-corrosion layer includes a second anti-corrosion layer 315.

Here, the second anti-corrosion layer 315 is disposed on an outer side of the heat exchange assembly 30 and configured to reduce corrosion on the heat exchange assembly 30 by external corrosive substances.

For example, the second anti-corrosion layer 315 has good resistance to acid and alkali corrosion.

For example, a side of the rigid member 32 facing away from the flexible member 31 is provided with the second anti-corrosion layer 315.

In other words, the side of the rigid member 32 facing away from the medium flow channel 312, that is, an outer side of the rigid member 32, is provided with the second anti-corrosion layer 315. The second anti-corrosion layer 315 can reduce corrosion on the rigid member 32 by external corrosive substances, thereby improving the reliability of the heat exchange assembly 30.

For example, a side of the flexible member 31 facing away from the rigid member 32 is provided with the second anti-corrosion layer 315.

In other words, the side of the flexible member 31 facing away from the medium flow channel 312, that is, an outer side of the flexible member 31, is provided with the second anti-corrosion layer 315. The second anti-corrosion layer 315 can reduce corrosion on the flexible member 31 by external corrosive substances, thereby improving the reliability of the heat exchange assembly 30.

In some embodiments, a side edge of the heat exchange assembly 30 is provided with the second anti-corrosion layer 315. In other words, the second anti-corrosion layer 315 covers the side edge of the heat exchange assembly 30.

Thus, on one hand, the second anti-corrosion layer 315 can reduce corrosion on the side edges of the flexible member 31 and the rigid member 32 by external corrosive substances. On the other hand, the second anti-corrosion layer 315 can also reduce external corrosive substances infiltrating a gap between the flexible member 31 and the rigid member 32 from a connection position between the flexible member 31 and the rigid member 32, further improving the reliability of the heat exchange assembly 30.

In some embodiments, one of the flexible member 31 and the rigid member 32 forms a flange portion, and the flange portion at least covers a side edge of the other one.

For example, the flexible member 31 forms a flange portion, and the flange portion at least covers a side edge of the rigid member 32.

The flange portion at least covering the side edge of the rigid member 32 means that the flange portion can cover only the side edge of the rigid member 32 or cover a portion of a sidewall of the rigid member 32 facing away from the flexible member 31.

For example, the rigid member 32 forms a flange portion, and the flange portion at least covers a side edge of the flexible member 31.

The flange portion at least covering the side edge of the flexible member 31 means that the flange portion can cover only the side edge of the flexible member 31 or cover a portion of a sidewall of the flexible member 31 facing away from the rigid member 32.

In these embodiments, the flange portion is formed, and the flange portion at least covers the side edge of the other one, further reducing external corrosive substances infiltrating the gap between the flexible member 31 and the rigid member 32 from the connection position between the flexible member 31 and the rigid member 32, thereby further improving the reliability of the heat exchange assembly 30.

In some embodiments, the second anti-corrosion layer 315 includes nylon.

Here, the second anti-corrosion layer 315 may be a nylon layer formed of a nylon material, so that the second anti-corrosion layer 315 has certain corrosion resistance, for example, resistance to acid and alkali corrosion.

In some embodiments, the flexible member 31 includes a metal-plastic composite film.

The flexible member 31 may be a single-layer or multi-layer film.

Here, the metal-plastic composite film is a metal-plastic composite material, that is, including a metal layer and a plastic layer.

In these embodiments, the metal-plastic composite film has a small thickness and low weight, and a medium flow channel 312 is formed between the metal-plastic composite film and the heat exchange member, so that the influence of an extrusion process is avoided, and the requirement for a large thickness does not need to be met. Therefore, the overall thickness and weight of the heat exchange assembly 30 can be reduced. Additionally, the insulating properties of the heat exchange assembly 30 can reduce the possibility of insulation failure. This reduces the risk of reaction between the heat exchange assembly 30 and the heat exchange medium flowing inside, further reducing the possibility of corrosion and leakage of the heat exchange medium.

For example, the flexible member 31 includes an aluminum-plastic film.

The aluminum-plastic film exhibits high barrier properties and good cold stamping formability, puncture resistance, electrolyte stability, and electrical insulation.

In some embodiments, the flexible member 31 is a layered structure, the flexible member 31 includes a metal layer and a non-metal layer, and the metal layer and the non-metal layer are sequentially stacked.

Here, the flexible member 31 includes the metal layer and the non-metal layer, that is, the flexible member 31 is a composite material member composed of the metal layer and the non-metal layer.

For example, the metal layer and the non-metal layer can be formed by hot-pressing or hot-melting.

Both the number of metal layers and the number of non-metal layers are not limited herein.

In these embodiments, the flexible member 31 including the metal layer and the non-metal layer sequentially stacked has a small thickness and low weight, and a medium flow channel 312 is formed between the flexible member 31 and the rigid member 32, so that the influence of an extrusion process is avoided, and the requirement for a large thickness does not need to be met. Therefore, the overall thickness and weight of the heat exchange assembly 30 can be reduced. Additionally, the heat exchange assembly 30 does not react with the heat exchange medium flowing inside, thereby eliminating the possibility of corrosion and leakage.

In some embodiments, the flexible member 31 is a layered structure, the flexible member 31 includes a metal layer and a non-metal layer, and the metal layer and the non-metal layer are sequentially stacked, where the non-metal layer is disposed on a side of the metal layer facing the rigid member 32.

In other words, the non-metal layer is located between the metal layer and the rigid member 32.

Here, providing the non-metal layer on the side of the metal layer facing the rigid member 32 allows for a hot-pressing connection to the rigid member 32 through the non-metal layer.

In some embodiments, the metal layer includes one or more of aluminum foil, copper foil, and steel foil.

Configuring the metal layer to be one or more of aluminum foil, copper foil, and steel foil allows the flexible member 31 to have certain structural strength and provide isolation.

In some embodiments, the non-metal layer includes one or more of polypropylene, polyphenylene sulfide, polyphthalamide, and polyethylene.

Configuring the non-metal layer to be one or more of polypropylene, polyphenylene sulfide, polyphthalamide, and polyethylene allows the flexible member 31 to have a certain waterproof effect.

For example, a non-metal layer made of a corrosion-resistant material with resistance to acid and alkali corrosion may alternatively be selected, or an additive is added to the non-metal layer such that the non-metal layer has resistance to acid and alkali corrosion.

In some embodiments, the non-metal layer is a hot-melt layer.

Here, configuring the non-metal layer as the hot-melt layer, that is, configuring the non-metal layer to be made of a hot-melt material, allows the non-metal layer to be easily compounded with the metal layer through hot-melting, thereby allowing for simple formation and high production efficiency.

In some embodiments, referring to FIGS. 3 and 4, the flexible member 31 is a layered structure, the flexible member 31 includes a first anti-corrosion layer 313, an isolation layer 314, and a second anti-corrosion layer 315 sequentially arranged, and the first anti-corrosion layer 313 is closer to the medium flow channel 312 than the second anti-corrosion layer 315.

Here, the second anti-corrosion layer 315 may be a nylon layer formed of a nylon material, so that the second anti-corrosion layer 315 has certain corrosion resistance, for example, resistance to acid and alkali corrosion.

The isolation layer 314 may be a metal layer. The metal layer may be configured to include one or more of aluminum foil, copper foil, and steel foil, allowing the flexible member 31 to have certain structural strength and provide isolation.

The first anti-corrosion layer 313 may be a non-metal layer. The non-metal layer may be configured to be one or more of polypropylene, polyphenylene sulfide, polyphthalamide, and polyethylene, allowing the flexible member 31 to have a certain waterproof effect.

In these embodiments, the flexible member 31 is configured to include the first anti-corrosion layer 313, the isolation layer 314, and the second anti-corrosion layer 315 sequentially arranged, and the first anti-corrosion layer 313 is closer to the medium flow channel 312 than the second anti-corrosion layer 315. This is conducive to improving the reliability of the heat exchange assembly 30.

In some embodiments, a thickness of the isolation layer 314 ranges from 6.5 μm to 100 μm.

The thickness of the isolation layer 314 may be any point value of 6.5 μm, 10 μm, 15 μm, 20 μm, 25 μm, 30 μm, 35 μm, 38 μm, 40 μm, 45 μm, 50 μm, 55 μm, 60 μm, 65 μm, 70 μm, 75 μm, 80 μm, 85 μm, 90 μm, 92 μm, 95 μm, or 100 μm, or a point value between any two of these values.

In these embodiments, setting the thickness of the isolation layer 314 to range from 6.5 μm to 100 μm allows the flexible member 31 to have certain structural strength and flexibility.

In some embodiments, the thickness of the isolation layer 314 ranges from 6.5 μm to 15 μm.

The thickness of the isolation layer 314 may be any point value of 6.5 μm, 7 μm, 7.5 μm, 7.8 μm, 8 μm, 8.3 μm, 8.5 μm, 8.8 μm, 9 μm, 9.2 μm, 9.5 μm, 9.7 μm, 10 μm, 10.3 μm, 10.5 μm, 10.8 μm, 11 μm, 11.5 μm, 11.8 μm, 12 μm, 12.3 μm, 12.5 μm, 13 μm, 13.5 μm, 14 μm, 14.5 μm, or 15 μm, or a point value between any two of these values.

In these embodiments, setting the thickness of the isolation layer 314 to range from 6.5 μm to 15 μm further allows the flexible member 31 to have certain structural strength and flexibility.

In some embodiments, a thickness of the second anti-corrosion layer 315 ranges from 5 μm to 20 μm.

The thickness of the second anti-corrosion layer 315 may be any point value of 5 μm, 5.5 μm, 5.8 μm, 6 μm, 6.5 μm, 7 μm, 7.5 μm, 7.8 μm, 8 μm, 8.3 μm, 8.5 μm, 8.8 μm, 9 μm, 9.2 μm, 9.5 μm, 9.7 μm, 10 μm, 10.3 μm, 10.5 μm, 10.8 μm, 11 μm, 11.5 μm, 11.8 μm, 12 μm, 12.3 μm, 12.5 μm, 13 μm, 13.5 μm, 14 μm, 14.5 μm, 15 μm, 15.5 μm, 16 μm, 16.5 μm, 17 μm, 17.5 μm, 18 μm, 18.5 μm, 18.7 μm, 19 μm, 19.5 μm, or 20 μm, or a point value between any two of these values.

In these embodiments, setting the thickness of the second anti-corrosion layer 315 to range from 5 μm to 20 μm can improve the wear resistance and toughness of the flexible member 31.

In some embodiments, a thickness of the first anti-corrosion layer 313 ranges from 50 μm to 120 μm.

The thickness of the first anti-corrosion layer 313 may be any point value of 50 μm, 55 μm, 60 μm, 65 μm, 70 μm, 75 μm, 80 μm, 85 μm, 90 μm, 92 μm, 95 μm, 100 μm, 105 μm, 108 μm, 110 μm, 115 μm, or 120 μm, or a point value between any two of these values.

In these embodiments, setting the thickness of the first anti-corrosion layer 313 to range from 50 μm to 120 μm allows the first anti-corrosion layer 313 to have certain structural strength, improves waterproof performance, and also facilitates hot-pressing connection of the flexible member 31 via the first anti-corrosion layer 313.

In some embodiments, a thickness of the flexible member 31 ranges from 0.05 mm to 0.3 mm.

For example, the thickness of the flexible member 31 may be any point value of 0.05 mm, 0.06 mm, 0.07 mm, 0.08 mm, 0.09 mm, 0.1 mm, 0.15 mm, 0.2 mm, 0.21 mm, 0.22 mm, 0.25 mm, 0.27 mm, 0.28 mm, or 0.3 mm, or a point value between any two of these values.

In these embodiments, setting the thickness of the flexible member 31 to range from 0.05 mm to 0.3 mm allows the heat exchange assembly 30 made from the flexible member 31 to have certain structural strength and allows the heat exchange assembly 30 to have a small overall thickness, helping to reduce the overall volume and weight of the battery apparatus 100, thereby increasing the energy density of the battery apparatus 100.

In some embodiments, the thickness of the flexible member 31 ranges from 0.08 mm to 0.2 mm.

For example, the thickness of the flexible member 31 may be any point value of 0.08 mm, 0.09 mm, 0.1 mm, 0.11 mm, 0.12 mm, 0.13 mm, 0.14 mm, 0.15 mm, 0.16 mm, 0.17 mm, 0.18 mm, 0.19 mm, or 0.2 mm, or a point value between any two of these values.

In these embodiments, setting the thickness of the flexible member 31 to range from 0.08 mm to 0.2 mm allows the heat exchange assembly 30 made from the flexible member 31 to have certain structural strength and further allows the heat exchange assembly 30 to have a small overall thickness, helping to further reduce the overall volume and weight of the battery apparatus 100, thereby further increasing the energy density of the battery apparatus 100.

In some embodiments, an elastic modulus of the flexible member 31 ranges from 0.1 MPa to 10000 MPa.

For example, the elastic modulus of the flexible member 31 may be any point value of 0.1 MPa, 1 MPa, 50 MPa, 100 MPa, 150 MPa, 200 MPa, 300 MPa, 500 MPa, 800 MPa, 1000 MPa, 1300 MPa, 1500 MPa, 1800 MPa, 2000 MPa, 2500 MPa, 2800 MPa, 3000 MPa, 3500 MPa, 4000 MPa, 4500 MPa, 5000 MPa, 5500 MPa, 6000 MPa, 6500 MPa, 7000 MPa, 7500 MPa, 8000 MPa, 8500 MPa, 8800 MPa, 9000 MPa, 9500 MPa, 9700 MPa, or 10000 MPa, or a point value between any two of these values.

The elastic modulus describes the magnitude of unit strain induced by unit stress when a solid material is subjected to force within a certain range, and is one of the fundamental physical properties of a material. A higher elastic modulus indicates higher stiffness and higher compressive resistance of the material. The elastic modulus is a physical quantity describing the elasticity of a material.

In these embodiments, setting the elastic modulus of the flexible member 31 to range from 0.1 MPa to 10000 MPa allows the flexible member 31 to have certain structural strength, improves the reliability of the heat exchange assembly 30, and allows the flexible member 31 to have certain deformability, improving the fit between the heat exchange assembly 30 and the casing 20 and/or the battery cells 10, thereby increasing the effective heat exchange area between the heat exchange assembly 30 and the casing 20 and/or the battery cells 10, and improving the heat exchange efficiency and heat exchange effect of the heat exchange assembly 30.

It should be noted that the specific material of the rigid member 32 is not limited herein.

In some embodiments, the rigid member 32 is configured as a metal plate.

For example, the metal plate may be an aluminum alloy.

In these embodiments, the rigid member 32 is configured as the metal plate, and the metal plate has both high structural strength and high thermal conductivity. In other words, this allows the heat exchange assembly 30 to have certain heat exchange efficiency and also allows the rigid member 32 to provide a certain support effect for the flexible member 31.

In some embodiments, the medium flow channel 312 includes a plurality of sub-flow channels, each battery cell 10 corresponds to a plurality of sub-flow channels, and extension directions of the sub-flow channels corresponding to the battery cell 10 are perpendicular to a length direction of the battery cell 10.

The plurality of sub-flow channels are interconnected to form the medium flow channel 312.

The extension directions of the sub-flow channels being perpendicular to the length direction of the battery cell 10 means that the plurality of sub-flow channels are arranged along the length direction of the battery cell 10, so that the length direction of the battery cell 10 corresponds to the plurality of sub-flow channels.

It can be understood that along a flow direction of the heat exchange medium, the temperature of the heat exchange medium gradually increases. Thus, configuring each battery cell 10 to correspond to a plurality of sub-flow channels is conducive to improving the temperature uniformity of the battery cell 10.

In a specific embodiment, referring to FIGS. 2 to 6, the battery apparatus 100 includes a casing 20, a heat exchange assembly 30, and a plurality of battery cells 10. The plurality of battery cells 10 are disposed within the casing 20. The heat exchange assembly 30 includes at least two heat exchange members, where at least one heat exchange member is configured as a flexible member 31, and at least one heat exchange member is configured as a rigid member 32. An elastic modulus of at least a partial region of the flexible member 31 is less than an elastic modulus of the rigid member 32. The flexible member 31 and the rigid member 32 are stacked to form at least one medium flow channel 312. The at least one medium flow channel 312 is configured to conduct a heat exchange medium, and the heat exchange medium is configured to exchange heat with the plurality of battery cells 10. The flexible member 31 and the rigid member 32 are hot-pressed to form a hot-pressed region 311 and a medium flow channel 312, and the flexible member 31 and the rigid member 32 are connected to each other in at least a partial region of the hot-pressed region 311.

In a specific embodiment, referring to FIGS. 3 and 4, the flexible member 31 is a layered structure, the flexible member 31 includes a first anti-corrosion layer 313, an isolation layer 314, and a second anti-corrosion layer 315 sequentially arranged, and the first anti-corrosion layer 313 is closer to the medium flow channel 312 than the second anti-corrosion layer 315. A thickness of the isolation layer 314 ranges from 6.5 μm to 15 μm. A thickness of the first anti-corrosion layer 313 ranges from 5 μm to 20 μm. A thickness of the second anti-corrosion layer 315 ranges from 50 μm to 120 μm. A thickness of the flexible member 31 ranges from 0.05 mm to 0.3 mm. An elastic modulus of the flexible member 31 ranges from 0.1 MPa to 10000 MPa.

A method for measuring the elastic modulus of the flexible member 31 may include at least one of a static tensile test method, a dynamic test method, an acoustic velocity method, a nanoindentation method, and a bending method. Measurement instruments may include a nanoindenter and a universal testing machine.

For example, at room temperature and normal pressure, the elastic modulus of the flexible member 31 can be measured using the nanoindentation method, where the nanoindentation method involves using a micro-indenter to create an indentation on a surface of the flexible member 31 and calculating the elastic modulus by analyzing a relationship between an indentation depth and a load.

In the description of the present disclosure, the description with reference to terms such as “in an embodiment”, “in some embodiments”, “in some other embodiments”, “in still some other embodiments”, or “for example” means that a specific feature, structure, material, or characteristic described in connection with the embodiment or example is included in at least one embodiment or example of the present disclosure. In the present disclosure, schematic expressions of the above terms do not necessarily refer to the same embodiment or example. Moreover, the specific features, structures, materials, or characteristics described can be combined in any suitable manner in any one or more embodiments or examples. Furthermore, without contradicting each other, persons skilled in the art can combine different embodiments or examples and features of different embodiments or examples described in the present disclosure.

The above descriptions are merely preferred embodiments of the present disclosure and are not intended to limit the present disclosure. For persons skilled in the art, the present disclosure may undergo various modifications and changes. Any modification, equivalent replacement, or improvement made without departing from the spirit and principle of the present disclosure shall fall within the protection scope of the present disclosure.

1. A battery apparatus, comprising:
a casing;
a plurality of battery cells, wherein the plurality of battery cells are disposed within the casing; and
a heat exchange assembly, wherein the heat exchange assembly comprises at least two heat exchange members, at least one of the heat exchange members is configured as a flexible member, at least one of the heat exchange members is configured as a rigid member, the flexible member and the rigid member are stacked to form at least one medium flow channel, the at least one medium flow channel is configured to conduct a heat exchange medium, and the heat exchange medium is configured to exchange heat with the plurality of battery cells;
wherein at least one of the flexible member and the rigid member comprises an anti-corrosion layer.

2. The battery apparatus according to claim 1, wherein the anti-corrosion layer comprises a first anti-corrosion layer, and the rigid member is provided with the first anti-corrosion layer in at least a region where the medium flow channel is formed.

3. The battery apparatus according to claim 2, wherein a side of the rigid member facing the flexible member is covered with the first anti-corrosion layer.

4. The battery apparatus according to claim 2, wherein the first anti-corrosion layer is configured as a metal-plastic composite film.

5. The battery apparatus according to claim 4, wherein the first anti-corrosion layer is configured as an aluminum-plastic film.

6. The battery apparatus according to claim 2, wherein the first anti-corrosion layer comprises one or more of polypropylene, polyphenylene sulfide, polyphthalamide, and polyethylene; or
the first anti-corrosion layer is a layered structure, and at least a layer of the first anti-corrosion layer close to the medium flow channel comprises one or more of polypropylene, polyphenylene sulfide, polyphthalamide, and polyethylene.

7. The battery apparatus according to claim 2, wherein the first anti-corrosion layer is formed on the rigid member by hot-pressing.

8. The battery apparatus according to claim 1, wherein the anti-corrosion layer comprises a second anti-corrosion layer; and
a side of the rigid member facing away from the flexible member is provided with the second anti-corrosion layer; and/or
a side of the flexible member facing away from the rigid member is provided with the second anti-corrosion layer; and/or
a side edge of the heat exchange assembly is provided with the second anti-corrosion layer.

9. The battery apparatus according to claim 8, wherein the second anti-corrosion layer comprises nylon.

10. The battery apparatus according to claim 1, wherein one of the flexible member and the rigid member forms a flange portion, and the flange portion at least covers a side edge of the other one.

11. The battery apparatus according to claim 1, wherein the flexible member comprises a metal-plastic composite film.

12. The battery apparatus according to claim 11, wherein the flexible member comprises an aluminum-plastic film.

13. The battery apparatus according to claim 1, wherein the flexible member is a layered structure, the flexible member comprises a metal layer and a non-metal layer, and the metal layer and the non-metal layer are sequentially stacked, wherein
the non-metal layer is a hot-melt layer;
the metal layer comprises one or more of aluminum foil, copper foil, and steel foil; and/or
the non-metal layer comprises one or more of polypropylene, polyphenylene sulfide, polyphthalamide, and polyethylene.

14. The battery apparatus according to claim 1, wherein the flexible member is a layered structure, the flexible member comprises a first anti-corrosion layer, an isolation layer, and a second anti-corrosion layer sequentially arranged, and the first anti-corrosion layer is closer to the medium flow channel than the second anti-corrosion layer.

15. The battery apparatus according to claim 1, wherein a thickness of the flexible member ranges from 0.05 mm to 0.3 mm, wherein the thickness of the flexible member ranges from 0.08 mm to 0.2 mm.

16. The battery apparatus according to claim 1, wherein an elastic modulus of at least a partial region of the flexible member is less than an elastic modulus of the rigid member.

17. The battery apparatus according to claim 1, wherein an elastic modulus of the flexible member ranges from 0.1 MPa to 10000 MPa.

18. The battery apparatus according to claim 1, wherein the rigid member is configured as a metal plate.

19. A heat exchange assembly, wherein the heat exchange assembly comprises at least two heat exchange members, at least one of the heat exchange members is configured as a flexible member, at least one of the heat exchange members is configured as a rigid member, the flexible member and the rigid member are stacked to form at least one medium flow channel, the at least one medium flow channel is configured to conduct a heat exchange medium, and the heat exchange medium is configured to exchange heat with a plurality of battery cells;
wherein at least one of the flexible member and the rigid member comprises an anti-corrosion layer.

20. An electric apparatus, comprising the battery apparatus according to claim 1.
